(19) United States
(12) Patent Application Publication
(10) Pub. No.: US 2002/0176965 A1
(43) Pub. Date: Nov. 28, 2002

(54) RECYCLABLE IMAGE-RECORDING MEDIUM, SURFACE LAYER OF WHICH CONTAINS SURFACTANT

(76) Inventor: NAOKI YOSHIE, KYOTO-SHI (JP)

Correspondence Address: BURNS DOANE SWECKER & MATHIS L L P, POST OFFICE BOX 1404, ALEXANDRIA, VA, 22313-1404, US

(21) Appl. No.: 09/376,014

(22) Filed: Aug. 18, 1999

(30) Foreign Application Priority Data
Aug. 20, 1998 (JP) 10/234058
Aug. 11, 1999 (JP) 11/227447

(51) Int. Cl. B41M 5/00

(52) U.S. Cl. 428/195

(57) ABSTRACT

The present invention relates to a recyclable image-recording medium comprising a base layer and a surface layer. The surface layer comprises a water-swelling surface layer, containing a surfactant. Printed materials are quickly removed from the recyclable image-recording medium. The recyclable image-recording medium is excellent in durability.

This application is based on application(s) No. Hei 10-234058 and No. Hei 11-227447 filed in Japan, the contents of which are hereby incorporated by reference.

### BACKGROUND OF THE INVENTION

1. Field of the Invention

The present invention relates to an image-recording medium capable of being reused repeatedly wherein a printed material made to adhere to the image-recording medium by image formation in a copying machine, a printer, or the like is removable from the image-recording medium. More particularly, the present invention relates to an image-recording medium suitable for being applied to a removing means by physical frictional forces, such as a brushing method that uses an aqueous solvent such as water.

2. Description of the Related Art

Electrophotographic copying techniques using toners (so called copy simply) are popular now. Image-recording media such as paper and OHP sheets are used in large quantities.

Printed materials printed or copied on such image-recording media are not easily removed. Techniques for removing such printed materials are not yet ready for practical use. It is true that printed materials generated in large quantities in offices are discarded when they become unnecessary.

This is clearly not desirable from the viewpoint of environmental protection and natural resource preservation. Therefore, researches on techniques for reproducing or recycling image-recording media which would otherwise be discarded have been vigorously conducted. Japanese Patent Laid-Open No. Hei 7-311,523 and EP060152, for example, disclose methods wherein a swelling layer which swells by absorbing water is formed on the surface of an image-recording medium and images printed on the image-recording medium are removed by swelling the swelling layer with water.

In reality, however, the conventional methods have not been put into practical use, because of their inability to sufficiently and satisfactorily remove printed materials, because of poor removal of printed materials when a copying and removing process are repeated and because of problems involving the durability of the image-recording medium.

In particular, the conventional image-recording medium has such a problem as it takes much time for the surface layer to swell and such a defect as poor durability with respect to repetition.

### SUMMARY OF THE INVENTION

An object of the present invention is to provide a novel and useful recyclable image-recording medium that allows printed materials such as toners adhering thereto to be removed.

The present invention provides an image-recording medium comprising:

a base layer; and

a water-swelling surface layer containing a surfactant.

### BRIEF DESCRIPTION OF THE DRAWINGS

FIG. 1 is a schematic cross sectional view of an embodiment of an image-recording medium.

FIG. 2 is a schematic cross sectional view of another embodiment of an image-recording medium.

FIG. 3 is a process sequence diagram for explaining a printed material removing method.

FIG. 4 is a schematic view showing one example of a cleaning apparatus.

FIG. 5 is a schematic view showing one example of a cleaning apparatus.

FIG. 6 is a schematic view showing one example of a cleaning apparatus.

### DETAILED DESCRIPTION OF THE INVENTION

A first invention of the present application relates to an image-recording medium comprising:

a base layer; and

a water swelling surface layer containing a surfactant.

According to the invention, a surfactant is contained in the water-swelling surface layer. Thereby, the water-swelling surface layer can swell quickly and the durability of image-recording medium is improved.

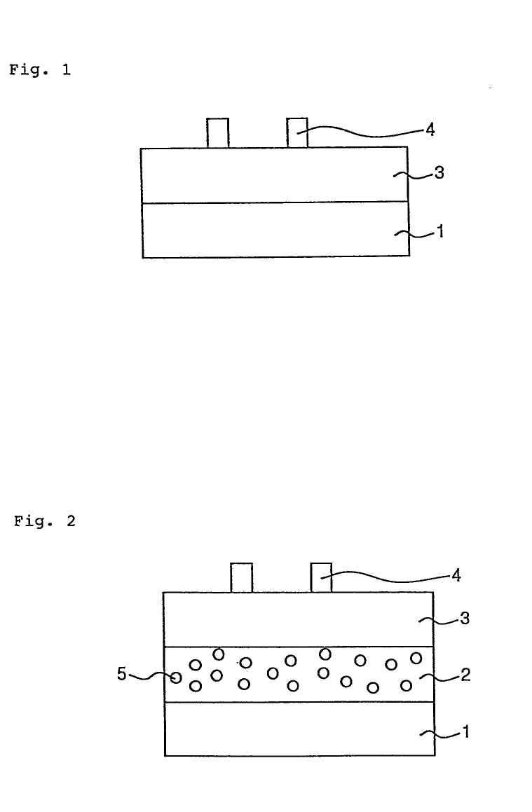

FIG. 1 shows a schematic cross sectional view of one embodiment of an image-recording medium. As shown in FIG. 1, the image-recording medium has a surface layer 3 laminated on a base layer 1. In the structure shown in FIG. 1, a printed material 4 is printed on the surface of the surface layer 3. In the structure shown in FIG. 1, the surface layer 3 is formed on one side of the base layer 1. Alternatively, the surface layer 3 may be formed on both sides thereof.

As a base layer 1, a transparent plastic film that has water-resistance (strength), or a plastic film opacified by adding inorganic fine particles, is used advantageously. The material of the plastic film is not specifically limited. When heat resistance, for example, is considered, polyester, polycarbonate, polyimide, polymethyl methacrylate, etc. are preferred. When versatility, price, heat resistance, durability, etc. are further considered, polyester, in particular, polyethylene terephthalate (PET), polyethylene naphthalate (PEN), etc. are desirable. Various sheets available as OHP sheets can also be used. In addition, plastic-based paper and other synthetic paper made from plastic fibers such as PET fibers are available in the market. These paper sheets can be used as the base material. Metal foils, paper with improved water-resistance, and even composite materials made from resin, paper, and metal can also be used. Other materials may be used so far as the material has water-resistance and appropriate mechanical strength and is able to keep its flatness throughout the printing and removal of printed materials.

The surface layer formed on the base layer comprises a water-swelling resin and a surfactant. The surfactant is contained in the surface layer, so that a water-absorbing rate of the surface layer is improved, a swelling rate of the surface layer is improved and repetitive removability of printed materials is improved.

Water-swelling means to swell with water or an aqueous solvent but not dissolve in it. The water-swelling resin may be produced by crosslinking a water-soluble resin. A water-insoluble component may be added to a water-soluble resin to yield the properties to absorb a water or other solvent to swell without dissolving in the solvent.

A water-soluble resin containing within a molecule a functional group having active hydrogen, such as a hydroxyl group, an amino group, an amide group, a thiol group, a carboxyl group, or a sulfonic group, can be used as the above mentioned water-soluble resin, examples of which include polyvinyl alcohol, methyl cellulose, polyacrylic acid, carboxymethyl cellulose, hydroxyethyl cellulose, polyvinyl pyrrolidone, polyacrylamide, and diacetone polyacrylamide. Preferably, polyvinyl alcohol, methyl cellulose, or polyacrylic acid is used. Among them, polyvinyl alcohol which has many hydroxyl groups is preferred, with a polymerization degree of 300 to 3,000, preferably 500 to 2,000, and more preferably 500 to 1,700. It is appropriate for use that such a water-soluble resin of 2 to 30 parts by weight, preferably 5 to 10 parts by weight, is dissolved in an aqueous solvent of 100 parts by weight.

In order to crosslink the water-soluble resin, a crosslinking agent and, if necessary, an initiator is added to the aqueous solution of the resin. Any crosslinking agent may be used as long as it has reactivity with the functional groups, such as a hydroxyl group, an amide group, a carboxyl group, etc., contained in the water-soluble resin molecules, and is capable of crosslinking the water-soluble resin. Examples include epoxy compounds, isocyanate compounds, glyoxals, methylol compounds, melamine compounds (melamine resins), dicarboxylic acids, aziridines, dihydrazides, etc.

When adding the above listed compounds as the crosslinking agent, 0.1 to 100 parts by weight, preferably 1 to 50 parts by weight, is added per 100 parts by weight of the water-soluble resin. If the amount is too low, the strength of the layer when swollen may be insufficient or the layer may be dissolved. If the amount is too large, the crosslinking agent may become a bulk component, causing problems in terms of the strength of the surface layer.

When the water-soluble resin is made insoluble by adding a water-insoluble component, it is preferable that a monomer or an oligomer having two or more vinyl groups and their polymerization initiator are added to a resin solution and the insoluble component is formed by heat polymerization or ultraviolet (UV) radiation curing.

Examples of the monomer or oligomer having two or more vinyl groups include diacrylates, dimethacrylates, and urethane acrylate-based monomers or oligomers.

The amount of such a monomer or oligomer to be added is determined by considering strength of the resulting surface layer when swollen with water and easiness of printed material removal. From this viewpoint, 10 to 150 parts by weight, preferably 30 to 100 parts by weight, may be added per 100 parts by weight of the water-soluble resin.

When a water-soluble or hydrophilic material is used as the crosslinking agent or the monomer or oligomer for forming the insoluble component, there is such an advantage as the surface layer can be formed with water. This serves to prevent an organic solvent from remaining in the surface layer, while at the same time, securing the safety during the coating process.

The surfactant contained in the surface includes, for example, an anionic surfactant, a cationic surfactant, a nonionic surfactant and any other surfactant. The anionic surfactant and the nonionic surfactant are preferable. Among them, it is preferable to use at least one of the surfactant selected from the group consisting of the following forumulas;

R₁—R₂—O—(EO)n₁H (i)

in which R₁ is an alkyl group having carbon atoms of 7 to 14; R₂ is a phenylene group or a naphthylene group; and n₁ is an integer of 3 to 40, preferably 5 to 10;

R₃—O—(EO)n₂H (ii)

in which R₃ is an alkyl group having carbon atoms of 7 to 14; and n₂ is an integer of 3 to 40, preferably 5 to 10;

R₄—R₅—SO₃—A (iii)

in which R₄ is an alkyl group having carbon atoms of 7 to 14; R₅ is a phenylene group or a naphthylene group; and A is an alkali metal;

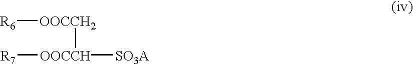

in which R₆ and R₇ are respectively an alkyl group having carbon atoms of 7 to 14; and A is an alkali metal;

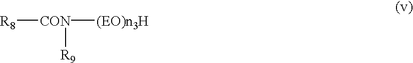

in which R₈ is an alkyl group having carbon atoms of 7 to 20; R₉ is a hydrogen atom or —CH₂CH₂OH; and n₃ is an integer of 1 to 10;

R₁₀O(EO)n₄SO₃A (vi)

in which R₁₀ is an alkyl group having carbon atoms of 7 to 15; n₄ is an integer of 1 to 10; and A is an alkali metal; and

R₁₁O(EO)n₅SO₃NH((EO)n₆H)₃ (vii)

in which R₁₁ is an alkyl group having carbon atoms of 7 to 14; n₅ is an integer of 0 to 7; and n₆ is an integer of 1 to 3.

Among nonionic surfactants, the ones having HLB of 9-15 are preferable. The use of such a nonionic surfactant effects to improve removability of printed materials and repetitive removability thereof.

As a nonionic surfactant having HLB of 9-15, polyoxyethylene alkyl phenyl ether, polyoxyethylene alkyl ether, ethylene oxide (EO) adducts of higher alcohol in which the number of EO is about 4 to about 20 may be exemplified without intention to limit to them. Other than them, esters of polyalcohols (glycerine, sorbit, sorbitan etc.) and higher fatty acid may be exemplified.

The compound represented by the general formula (i) is preferable as a polyoxyethylene alkyl phenyl ether and exemplified by polyoxyethylene nonyl phenyl ether, polyoxyethylene dodecyl phenyl ether, polyoxyethylene octyl phenyl ether.

The compound represented by the general formula (ii) is preferable as a polyoxyethylene alkyl ether and exemplified by polyoxyethylene nonyl ether, polyoxyethylene octyl ether and polyoxyethylene dodecyl ether.

The compound represented by the general formula (iii) may be exemplified with no intention to limit the compounds by sodium dodecylbenzenesulfonate etc.

The compound represented by the general formula (iv) may be exemplified with no intention to limit the compounds by sodium dialkylsulfosuccinate etc.

The compound represented by the general formula (v) may be exemplified with no intention to limit the compounds by polyoxyethylene alkyl fatty acid ethanolamide such as polyoxyethylene coconut oil fatty acid monoethanolamide, and alkyl fatty acid ethanolamide such as coconut oil fatty acid diethanolamide and lauric acid diethanolamide etc.

The compound represented by the general formula (vi) may be exemplified with no intention to limit the compounds by sodium polyoxyethylene alkyl ether sulfonate etc.

The compound represented by the general formula (vii) may be exemplified with no intention to limit the compounds by polyoxyethylene alkyl ether sulfonate triethanolamine such as polyoxyethylene lauryl ether sulfonate triethanolamine etc.

Inorganic fine particles, such as silica, titanium oxide, alumina, zinc oxide and calcium carbonate, or fine resin particles, such as acrylic resin, styrene resin, maybe added to the surface layer to improve writing or printing properties. When such inorganic fine particles are added, 1 to 200 parts by weight, preferably 1 to 50 parts by weight, is added per 100 parts by weight of the water-soluble resin.

The average particle size of the secondary particles of these fine particles (the secondary particle size) is preferably not smaller than 5 μm and not larger than 30 μm. If the particle size is smaller than 5 μm, a discernible effect is difficult to obtain in terms of writing or printing properties. If it exceeds 30 μm, a problem on image quality may arise. The secondary particle size here refers to the particle size when an agglomerate formed of agglomerated fine particles is regarded as a single particle. The secondary particle size can be measured, for example, by means of a microscope.

If desired, an antistatic treatment may be applied to the surface layer in order to enhance the paper-feeding ability. The antistatic agent maybe added to the surface layer, or may be dissolved and dispersed in a suitable solvent and applied after the surface layer is formed. The antistatic agent may be exemplified by a cationic surfactant such as quaternary ammonium salt.

A solvent-coating method can be used to form the surface layer. To describe more specifically, the water-swelling resin, that is, the water-soluble resin and crosslinking agent or the water-soluble resin, monomer or oligomer, and the surfactant, if necessary, other additives are dissolved and/or dispersed in a suitable solvent such as water, a water/organic mixed solvent, or an organic solvent, and the resulting solution is applied onto the base layer to form a layer thereon to have a thickness of 0.5 μm to 30 μm, preferably 3 μm to 20 μm, and more preferably 5 μm to 20 μm when measured after heating and drying. When the surface layer is formed by the coating method with an aqueous solvent, such an effect as easy formation of the surface by the coating method is obtained when the coating solution contains the surfactant.

After coating, the surface layer is heated at 50° C. to 180° C., preferably at 80° C. to 150° C. If the insolubilizing component is to be formed by photoirradiation within the surface layer, the heating is performed after or simultaneously with the photoirradiation.

An intermediate layer may be formed between the base layer and the surface layer. The intermediate layer is formedinorder to adhere the surface layer stronger to the base layer.

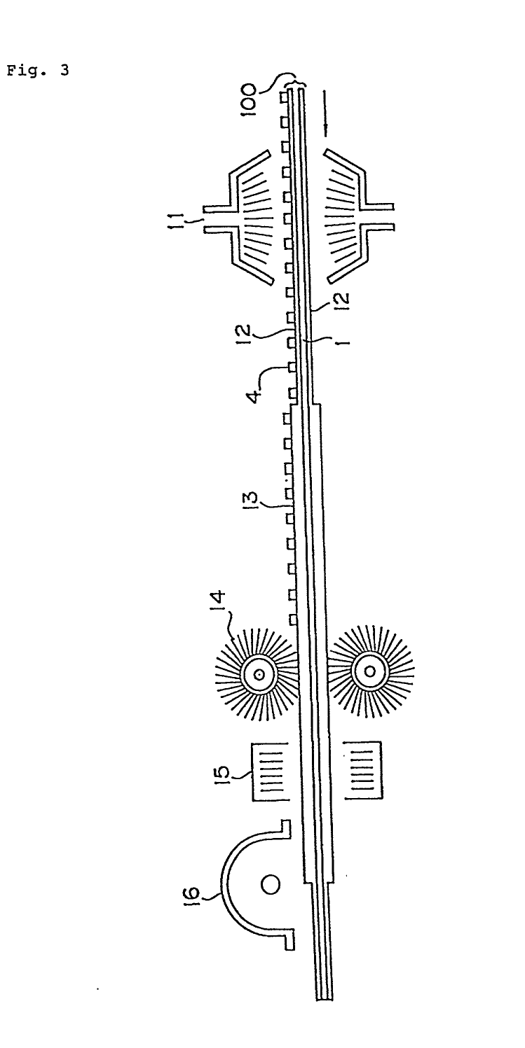

FIG. 2 shows a schematic cross sectional view of another embodiment of the image-recording medium having the intermediate layer. Reference number 1 is a base layer, 2 is an intermediate layer, 3 is a surface layer. In the structure shown in FIG. 2, a printed material 4 is printed on the surface of the surface layer 3. In the structure shown in FIG. 2, the intermediate layer 2 and the surface layer 3 are formed on one side of the base layer 1. Alternatively, the intermediate layer 2 and the surface layer 3 may be formed on both sides thereof.

The intermediate layer 2 is formed from a resin with high adhesive properties. The intermediate layer may contain a compound (reactive compound) 5 having a functional group chemically bondable to the surface layer-forming resin, if desired.

Examples of the resin with high adhesive properties for forming the intermediate layer 2 include acrylate resins, styrene resins, polyester resins, polycarbonate resins, vinyl acetate resins, vinyl chloride resins, urethane resins, etc., among which polymethyl methacrylate resins, polyester resins, polycarbonate resins, vinyl chloride resins, and urethane resins are preferable. In particular, resins having high adhesivity to the base layer are preferred for use.

The reactive compound contained in the intermediate layer is not limited to a specific compound as long as it has a functional group capable of chemically bonding to the surface layer-forming resin. For example, methylol compounds, isocyanate compounds, aldehyde compounds, epoxy compounds, aziridine compounds, etc. can be used. When the surface layer-forming resin is a resin having a hydroxyl group, such as polyvinyl alcohol or methyl cellulose, methylol compounds, isocyanate compounds, aldehyde compounds, and epoxy compounds are preferred. When the surface layer-forming resin is a resin having a carboxyl group, such as polyacrylic acid, then isocyanate compounds, epoxy compounds, and aziridine compounds are preferred. These compounds can be also used as the crosslinking agent for crosslinking the water-soluble resin to form the surface layer.

Examples of methylol compounds include methylol melamines such as dimethylol melamine and trimethylol melamine, dimethylol ureas, and melamine-formaldehyde resins. Various other methylol compounds can also be used; those having an appropriately high molecular weight and appropriately long molecular chain are more preferable. From this point of view, melamine-formaldehyde resins are most preferable among the above listed methylol compounds.

Examples of aldehyde compounds include glyoxal and glutaraldehyde. Various other aldehyde compounds can also be used.

Examples of epoxy compounds include polyethylene glycol diglycidyl ether, polypropylene glycol diglycidyl ether, sorbitol polyglycidyl ether, sorbitan polyglycidyl ether, and polyglycerol polyglycidyl ether. Various other epoxy compounds can also be used.

For isocyanate compounds, a compound containing two or more isocyanate groups within one molecule can be used. Using a compound containing a plurality of isocyanate groups, the base layer and the surface layer can be bonded together more firmly.

Such isocyanates include, for example, 4,4′-diphenylmethane di-isocyanate, 4,4′-methylene biscyclohexyl isocyanate, tris(p-isocyanatephenyl)thiophosphate, tris(p-isocyanatephenyl) methane, adduct of trimethylolpropane with three tolylene di-isocyanates, and aliphatic polyisocyanates containing a hydrophilic group within molecule.

The isocyanates used in the present invention, including the above listed compounds, may be protected by phenol, sulfurous acid, etc.

Examples of aziridine compounds include, for example, diphenylmethane-bis-4,4′-N,N′-diethyl urea and 2,2-bishydroxylmethylbutanol-tris-[3-(1-aziridinyl)propionate]. Polymers containing an oxazoline group can also be used.

For the above described reactive compounds, compounds that are in the form of a solid or wax at normal temperatures or in the form of a viscous liquid at normal temperatures are more preferable. When the reactive compound is in the form of a solid or wax or a viscous liquid at normal temperatures, the advantage is that the compound does not evaporate by drying in the process of forming the intermediate layer and, also, the surface does not become sticky after drying, which makes the surface coating easier. Further, when the reactive compound soluble in water or having affinity for water is used, there is no need to use an organic solvent when forming the intermediate layer, which serves to prevent an organic solvent from remaining in the intermediate layer.

In order to apply the intermediate layer 2 onto the base layer 1, a solution-coating method, a melt-coating method etc. can be employed. In the solution-coating method, a solution prepared by dissolving the resin and, if necssary, the reactive compound in a suitable solvent, such as tetrahydrofuran (THF), dioxane, acetone, ethyl acetate or methyl ethyl ketone (MEK), is applied and dried. A solution of a water-soluble or hydrophilic polyurethane, polyester, or other resin dispersed or dissolved in water can also be used. Such resin solutions and resin emulsions are commercially available. Such solutions or emulsions have the advantage that the coating can be performed without use of an organic solvent, especially, a nonaqueous organic solvent. This effects to improve the safety during manufacturing. This also effects to prevent problems such as generation of residual solvent gases from within the image-recording medium when it is fed, for example, into a copying machine and heated. The use of an aqueous solvent has an effect of facilitating the application of the intermediate layer when a surface active agent is added. When both the intermediate layer and the surface layer are formed by use of an aqueous solvent, it becomes possible to prepare an image-recording medium without use of a non-aqueous organic solvent. Safety is secured and the remaining of the non-aqueous organic solvent in the image-recording medium may be avoided. By means of the solution-coating method or the melt-coating method described above, the intermediate layer is formed to have a layer thickness of about 0.5 μm to 20 μm, preferably about 0.5 μm to 10 μm, more preferably about 0.5 μm to 6 μm. If the thickness is less than 0.5 μm, coating irregularities tend to occur, tending to result in the formation of uncoated portions. If the thickness exceeds 20 μm, problems may arise in strength and heat resistance etc. of the image-recording medium.

The reactive compound can itself be dissolved in a solvent or the like and then applied and dried for formation of the intermediate layer, when it is a high molecular weight compound that has a layer-forming capability by itself and excellent adhesivity to the base layer. When adding the compound to the resin solution for coating, 5 to 50 parts by weight of the reactive compound may be added per 100 parts by weight of the intermediate layer-forming resin.

Further the intermediate layer may be subjected to a corona discharge treatment.

When paper or fibrous base is used, the base may be immersed in a coating solution for formation of the intermediate layer, thereby impregnating the base material with the coating solution and filling the intermediate layer-forming material through fibers of the base material.

The above obtained image-recording medium can be used repeatedly in a recycling system in which printed image-removing method involves the processes of a surface layer-swelling process, a physical friction process, such as brushing, and a drying process. It is thought that when a surfactant exists in the surface layer in the layer-swelling process, water-absorbing properties are improved and the surface swells quickly. In addition, as the surfactant is contained in the surface in advance, the surfactant may remain in the surface even after the image-recording medium is repeatedly used. The swelling properties of the surface may be kept, and the durability of the image-recording medium may be improved.

The following describes a method for removing a printed material from an image-recording medium whose surface is printed with a printed material such as toner. This method comprises the step of feeding the image-recording medium printed with a printed material to a solvent capable of swelling the surface layer, and the step of scraping the printed material from the swollen surface of the image-recording medium by a physical force. The method will be further described in detail with reference to figures.

FIG. 3 is a process sequence diagram for explaining one example of the printed material-removing method. In FIG. 3, an intermediate layer and a surface layer are formed on both sides of the image-recording medium 100. The intermediate layer and the surface layer are designated in toto by reference number 12. The surface of the image-recording medium is printed with a material for printing 4 such as toner. Toner used in electrophotography is preferably used as the material for printing. Other types of materials for printing can also be used, including such materials for printing as used in an ink jet method in which hot-melt ink is used, a thermal transfer method, or other printing processes. Other types of materials for printing, such as oil paint, that adheres to the surface of an image-recording medium to form a veliform image. The image-recording medium is transported from right to left in the figure.

First, the image-recording medium printed with the printed material 4 is supplied on its surface layer with a surface layer-swelling solvent from a solvent supplier 11. Various solvents, including an aqueous solvent such as water or a mixed solvent of water and a water-soluble organic solvent, or an aqueous organic solvent, can be used as the solvent capable of swelling the surface layer. An additive such as a surfactant may be added to the solvent. In this way, the present invention has a great advantage in that the printed material can be removed with water. The following description deals with the case in which water is used.

Water may be supplied by spraying a shower of water over the surface layer from a shower device 11, as shown in FIG. 3. The surface layer may be immersed in water (not illustrated in the figure). It is preferable to expose the surface layer to water for about 15 to 150 seconds to allow water to soak into the surface layer of the image-recording medium. As the contact time increases, the water can be made to soak sufficiently, but the processing time increases correspondingly. When the water soaks into the surface layer of the image-recording medium, the surface layer swells (the swollen surface layer is shown by reference number 13) and the adhesion between a printed material 4 and the surface layer decreases. At this time, it is appropriate that the water temperature is kept at 15° C. to 45° C. If the temperature is too high, the amount of water evaporation increases. If the temperature is too low, a sufficient cleaning effect may not be obtained.

After the water has sufficiently soaked through the surface layer, the image-recording medium is transported to a printed material-removing region where a brush 14 is applied. The brush 14 is rotating so that the printed material 4 on the image-recording medium 100 is removed by the brush. A removing means other than the brush may be used, for example, a means such as a blade or a cloth that rubs or scrapes the surface by applying a physical or mechanical force to the surface. In FIG. 3, the brush 14 is disposed away from the liquid, but may be placed in the liquid. A length of the brush 14 may be about 5 mm to 20 mm and the thickness about 10 μm to 60 μm. The material is not specifically limited, but nylon or the like is suitable.

The paper feed speed, i.e., the speed at which the image-recording medium passes under the brush 14, is determined by considering the balance between the processing time and the cleaning performance; for example, the speed is set within the range of 0.5 cm/second to 5 cm/second. Preferably, the rotational speed of the brush is set at five or more times the transport speed, and more preferably at 10 or more times.

After the printed material 4 has been removed, the image-recording medium is transported to a shower region where a cleaning shower 15 is supplied to the surface of the image-recording medium to wash out any remaining printed material on the surface of the image-recording medium. An aqueous solvent similar to the one used to swell the surface may be used as the liquid for the shower 15. It is particularly preferable to use water.

After subjected to the shower 15, the image-recording medium is transported to a drying region where it is dried by a dryer 16. The drying method may be accomplished either by a contact type such as a heat roller or by a noncontact type such as a far infrared lamp. A heating temperature is suitably in the range of 70 to 150° C.

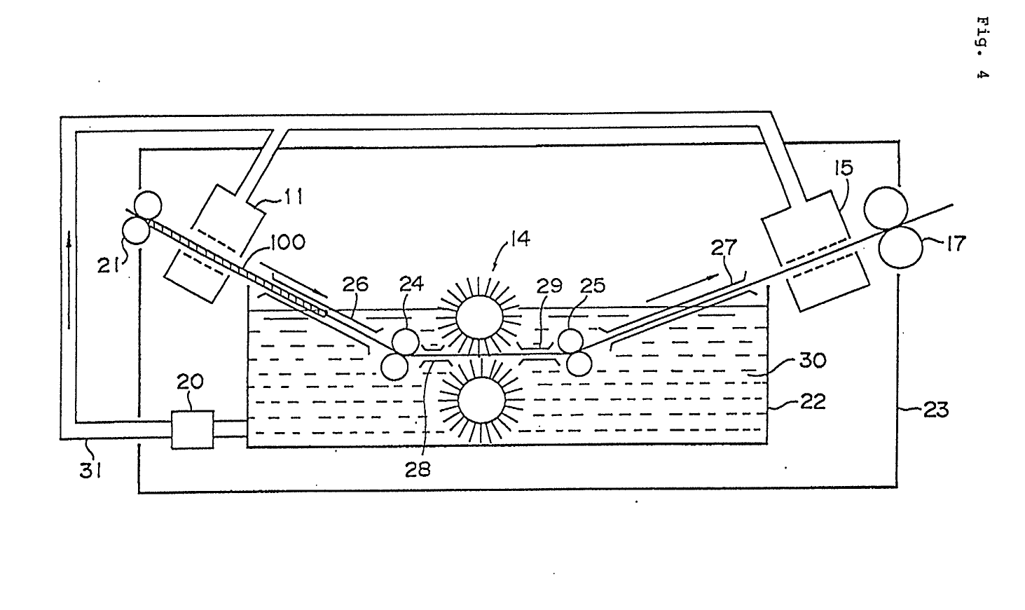

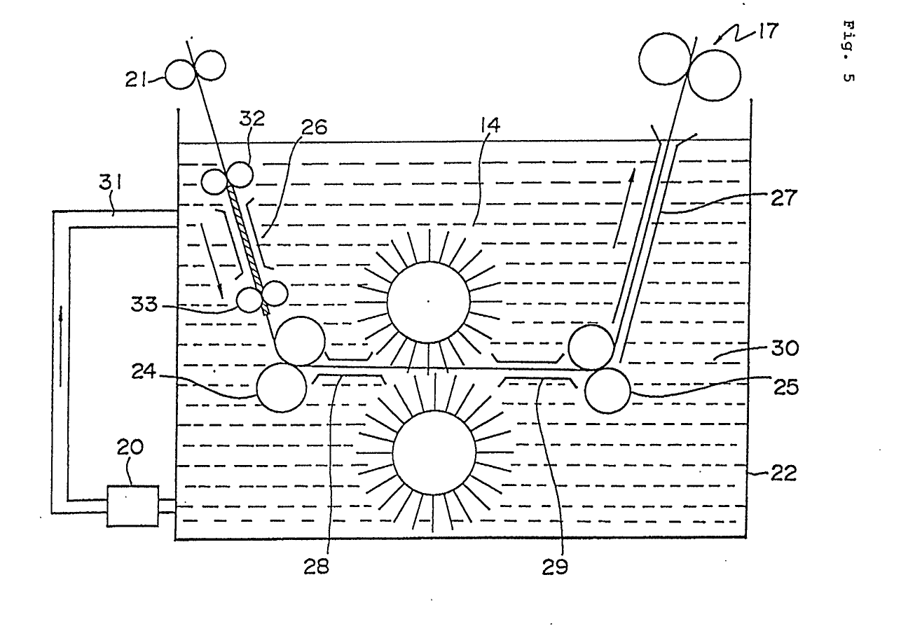

FIG. 4 is a diagram showing one embodiment of a cleaning apparatus to which the above described cleaning method can be applied. The apparatus of FIG. 4 includes a cleaning tank 22, mounted inside a casing 23, for accommodating a liquid 30 for swelling the image-recording medium. To the cleaning tank 22 is connected a pump 20 equipped with a filter for removing the printed material in the liquid in the tank, and the pump 20 is further connected via a pipe 31 to a swelling shower 11 and a rinsing shower 15.

The liquid in the cleaning tank 22, after being purified by the filter in the pump 20, is fed through the pipe 31 to the showers 11 and 15, and is used as a liquid for swelling the image-recording medium in the shower 11 and as a liquid for rinsing in the shower 15.

The image-recording medium is fed into the apparatus by means of a paper feeding roller 21 and sprayed with the liquid for swelling from the shower 11. Then, the image-recording medium is transported via a guide 26 and a transport roller 24 and immersed in the liquid 30 in the cleaning tank 22. After immersed for a prescribed period of time, the image-recording medium is fed by means of the transport roller 24 and a guide 28 to a position facing to the brush 14, where the printed material is removed.

The image-recording medium is, then, transported via a guide 29, a transport roller 25, and a guide 27, is sprayed with the rinsing liquid from the shower 15, and is finally dried by a drying roller 17 and discharged to the outside of the apparatus.

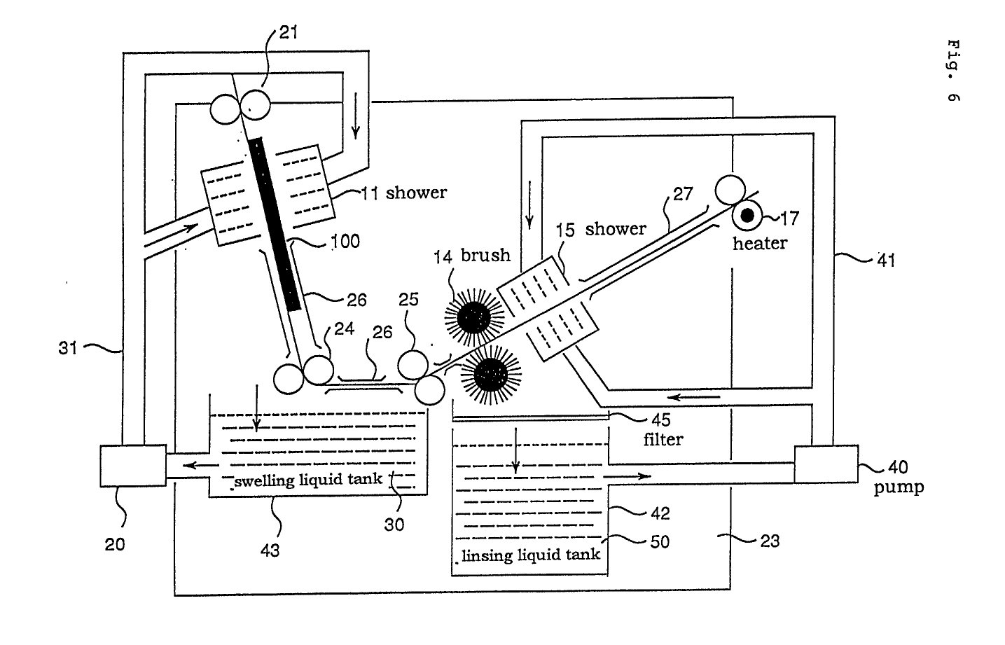

FIG. 5 is a diagram showing another embodiment of the cleaning apparatus. In the apparatus of FIG. 5, the image-recording medium fed by means of a paper feed roller 21 is transported directly into a cleaning tank 22 by means of transport rollers 32, 33 and a guide 26, and immersed in a liquid 30 to allow water to soak into the surface layer of the image-recording medium before brushing. After passing the position facing to a brush 14, the image-recording medium is passed through the liquid 30 for a prescribed period of time before being fed to a drying roller 17, thereby obtaining the rinsing effect. The same components as those in FIG. 4 are designated by the same reference numbers, and detailed explanations of such components are omitted.

FIG. 6 is a diagram showing yet another embodiment of the cleaning apparatus. In this apparatus, a swelling liquid tank 43, for accommodating a liquid 30 for swelling the image-recording medium, and a rinsing liquid tank 42, for accommodating a liquid for cleaning the image-recording medium after its surface has been rubbed by a brush 14, are provided independently of each other. The liquid 30 accommodated in the swelling liquid tank 43 is pumped up by a pump 20 equipped with a filter, and fed through a pipe 31 to the shower 11 where the liquid is sprayed for a prescribed period of time or in a prescribed quantity over the image-recording medium 100 being fed by a paper feed roller 21. The image-recording medium is transported to a brushing region 14 via a guide 26 and transport rollers 24 and 25. The swelling liquid sprayed on the image-recording medium from the shower 11 drops downward and is returned to the swelling liquid tank 43, located downward of the shower 11, and the liquid is thus circulated for reuse.

The image-recording medium 100 from which the printed material has been removed by the brush 14 is transported to a shower 15 where the cleaning shower 15 is supplied to the surface of the image-recording medium. A rinsing liquid 50 accommodated in the rinsing liquid tank 42 is pumped up by a pump 40 equipped with a filter, and supplied as the cleaning shower to the shower region through a pipe 41. The printed material scraped off by the brush and the printed material washed off by the rinsing liquid fall onto a filter 45 provided above the rinsing liquid tank, while the cleaning shower liquid falling from the shower region also drops onto the filter; the printed material is filtered out, and the rinsing liquid is returned to the tank 42 and circulated for reuse.

The image-recording medium passed through the shower region is transported via a guide 27 and is finally dried by a drying roller 17 with a built-in heater and discharged to the outside of the apparatus.

### Example 1

Base layer: A polyethylene terephthalate (PET) sheet with a thickness of 100 μm was used as a base layer.

Intermediate layer: A resin solution was prepared by dissolving 14 g of a polycarbonate resin in 86 g of 1,4-dioxane. One gram of melamine-formaldehyde resin (Sumirez 613; made by Sumitomo Kagaku K.K.) was added to the resin solution and stirred. The resulting solution was applied onto the base layer by a bar coater, and heated at 80° C. for five minutes, followed by a corona discharge treatment, to form an intermediate layer of 3 μm thickness.

Surface layer: A resin solution was prepared by dissolving 12 g of polyvinyl alcohol CM-318 (made by Kuraray K.K.) a water-soluble resin in 188 g of water. The resin solution was added with 0.5 g of melamine-formaldehyde resin (Sumirez 613; made by Sumitomo Kagaku K.K.), 0.6 g of ammonium chloride and 0.2 g of polyoxyethylene nonyl phenyl ether (HLB=12.8) as a surfactant and stirred for five minutes.

The resulting solution was applied onto the intermediate layer by a bar coater, and heated at 120° C. for 2 hours to form a surface layer of 9 μm thickness.

### EXAMPLE 2

Base layer: A polyethylene naphthalate (PEN) sheet with a thickness of 80 μm was used as a base layer.

Surface layer: A resin solution was prepared by dissolving 12 g of polyvinyl alcohol CM-318 (made by Kuraray K.K.) as a water-soluble resin in 188 g of water. The resin solution was added with 4 g of aliphatic polyisocyanate (SBU0772: made by Sumitomo Bayer K.K.) as a crosslinking agent, and 1 g of sodium polyoxyethylene lauryl ether sulfate as a surfactant and stirred for five minutes. The resulting solution was applied onto the base layer by a bar coater, and heated at 140° C. for 60 minutes to form a surface layer of 8 μm thickness.

### EXAMPLE 3

Base layer: A white PET sheet with a thickness of 100 μm was used as a base layer.

Intermediate layer: A resin solution was prepared by dissolving 12 g of a polyvinyl chloride resin in 188 g of tetrahydrfuran. Four grams of isocyanate (Desmodur RFE; made by Sumitomo Bayer K.K.) were added to the resin solution and stirred. The resulting solution was applied onto the base layer by a bar coater, and heated at 60° C. for five minutes to form an intermediate layer of 3 μm thickness.

Surface layer: A resin solution was prepared by dissolving 12 g of polyvinyl alcohol PVA-220 (made by Kuraray K.K.) as a water-soluble resin in 188 g of water. The resin solution was added with 6 g of polyethylene glycol diglycidyl ether (Dinacol EX-832; made by Nagase Kasei K.K.) as a crosslinking agent, 0.5 g of polyoxyethylene dodecyl phenyl ether (HLB=13.4) as a surfactant and stirred for five minutes.

The resulting solution was applied onto the intermediate layer by a bar coater, and heated at 140° C. for 2 hours to form a surface layer of 5 μm thickness.

### EXAMPLE 4

Base layer: An OHP sheet (BG-65; made by Folex K.K.) with a thickness of 100 μm was used as a base layer.

Surface layer: A resin solution was prepared by dissolving 12 g of polyvinyl alcohol PVA-117 (saponification degree of 100%; made by Kuraray K.K.) in 188 g of water. The resin solution was added with 6 g of polyethylene glycol diacrylate (A-1000; made by Shin-Nakamura kagaku K.K.), 1 g of sodium dialkylsulfosuccinate as a surfactant and 1 g of potassium persulfate as an initiator, and stirred for five minutes. The resulting solution was applied onto the base layer by a bar coater, and heated at 120° C. for 30 minutes to form a surface layer of 8 μm thickness.

### EXAMPLE 5

Base layer: A PET sheet with a thickness of 150 μm was used as a base layer.

Intermediate layer: A resin solution was prepared by dissolving 14 g of a polycarbonate resin in 186 g of tetrahydrofuran. Two grams of melamine-formaldehyde resin (Sumirez 613; made by Sumitomo Kagaku K.K.) was added to the resin solution and stirred. The resulting solution was applied onto the base layer by a bar coater, and heated at 80° C. for 3 minutes, to form an intermediate layer of 3 μm thickness.

Surface layer: A resin solution was prepared by dissolving 10 g of methyl cellulose in 190 g of water. The resin solution was added with 0.5 g of melamine-formaldehyde resin (Sumirez 613; made by Sumitomo Kagaku K.K.), 1 g of sodium dodecylbenzenesulfonate as a surfactant and stirred for five minutes.

The resulting solution was applied onto the intermediate layer by a bar coater, and heated at 120° C. for 2 hours to form a surface layer of 5 μm thickness.

### EXAMPLE 6

Base layer: A PET sheet with a thickness of 150 μm was used as a base layer.

Intermediate layer: Five grams of a melamine-formaldehyde resin (SUMIREZ 613: made by Sumitomo Kagaku K.K.) and 0.1 g of polyoxyethylene octyl phenyl ether (OCTAPOL 100; made by Sanyo Kasei K.K.) were added to 100 g of an urethane-resin-water-dispersion (HUX-232) and stirred. The resulting solution was applied onto the base layer by a bar coater, and heated at 120° C. for five minutes to form an intermediate layer of 3 μm thickness.

Surface layer: A resin solution was prepared by dissolving 12 g of polyvinyl alcohol KL-318 (made by Kuraray K.K.) as a water-soluble resin in 188 g of water. Polyethylene glycol diglycidyl ether (Dinacol EX-832: made by Nagase Kasei K.K.)(0.6 g) as a crosslinking agent, 0.1 g of polyoxyethylene coconut oil fatty acid monoethanolamide as a surfactant, 2 g of silica fine particles (SYLYSIA 350: made by Fuji Sylysia K.K.) as an inorganic fine particles were added to the resin solution and stirred for five minutes. The resulting solution was applied onto the intermediate layer by a bar coater, and heated at 120° C. for 2 hours to form a surface layer of 8 μm thickness.

### EXAMPLE 7

Base layer: A CF paper sheet treated by corona discharge was used as a base layer.

Intermediate layer: Five grams of a melamine-formaldehyde resin (SUMIREZ 613: made by Sumitomo Kagaku K.K.) and 0.2 g of polyoxyethylene alkyl ether (Emarumine L-90-S; made by Sanyo Kasei K.K.) were added to 100 g of an urethane-resin-water-dispersion (HUX-232) and stirred. The resulting solution was applied onto the base layer by a bar coater, heated at 120° C. for five minutes and subjected to corona discharge treatment.

Surface layer: A resin solution was prepared by dissolving 20 g of polyvinyl alcohol KM-618 (made by Kuraray K.K.) as a water-soluble resin in 180 g of water. Glycerol polyglycidyl ether (EX-313: made by Nagase Kasei K.K.)(4 g) as a crosslinking agent, 0.4 g of polyoxyethylene alkyl ether (Emarumine L-90-S; HLB=13.2; made by Sanyo Kasei K.K.), 4 g of silica fine particles (SYLYSIA 450: made by Fuji Sylysia K.K.) were added to theresinsolution. The resulting solution was applied onto the intermediate layer by a bar coater, and heated at 180° C. for 10 minutes to form a surface layer of 15 μm thickness.

### EXAMPLE 8

Base layer: A PET sheet with a thickness of 125 μm, which was treated by corona discharge, was used as a base layer.

Surface layer: A resin solution was prepared by dissolving 20 g of a polyvinyl alcohol KL-318 (made by Kuraray K.K.) in 180 g of water. The resulting resin solution was added with 4 g of glycerol polyglycidyl ether (EX-313; made by Nagase Kasei K.K.) as a crosslinking agent, 0.4 g of polyoxyethylene alkyl ether (Emarumine 50; HLB=9.0; made by Sanyo Kasei K.K.), 0.3 g of resin fine particles (Epostar MA1010; made by Nippon Shokubai K.K.) and 0.2 g of potassium hydroxide, and then stirred. The resulting solution was applied onto the base layer by a bar coater, and heated at 140° C. for 30 minutes to form a surface layer of 10 μm thickness.

### EXAMPLE 9

Base layer: A PET sheet with a thickness of 100 μm was used as a base layer.

Intermediate layer: Five grams of a melamine-formaldehyde resin (SUMIREZ 613; made by Sumitomo Kagaku K.K.), 0.2 g of polyoxyethylene alkyl ether (Emarumine L-90-S; made by Sanyo Kasei K.K.) were added to 100 g of an urethane-resin-water-dispersion (HUX-232; made by Asahi Denka K.K.) and stirred. The resulting solution was applied onto the base layer by a bar coater, heated at 120° C. for 5 minutes and subjected to corona discharge treatment.

Surface layer: A resin solution was prepared by dissolving 20 g of polyvinyl alcohol KM-618 (made by Kuraray K.K.) as a water-soluble resin in 180 g of water. Polyethylene glycol diglycidyl ether (EX-810; made by Nagase Kasei K.K.) (4 g) as a crosslinking agent, 0.4 g of ethylene oxide adduct of higher alcohol (Naroaquty N-85; HLB=12.6; made by Sanyo Kasei K.K.), 0.3 g of almina fine particles and 0.2 g of conc. hydrocholic acid were added to the resin solution. The resulting solution was applied onto the intermediate layer by a bar coater, and heated at 140° C. for 30 minutes to form a surface layer of 15 μm thickness.

### EXAMPLE 10

A base layer, an intermediate layer and a surface layer were formed in a manner similar to Example 7, except that triethanol amine polyoxyethylene alkyl ether sulfonate (Sanded ET; made by Sanyo Kasei K.K.) (0.2 g) was used instead of polyoxyethylene alkyl ether as a surfactant added into the surface layer.

### EXAMPLE 11

A base layer, an intermediate layer and a surface layer were formed in a manner similar to Example 7, except that ethyleneoxide adduct of higher alcohol (Naroaquty N-120; HLB=14.1; made by Sanyo Kasei K.K.) was used instead of polyoxyethylene alkyl ether as a surfactant added into the surface layer.

### EXAMPLE 12

A base layer, an intermediate layer and a surface layer were formed in a manner similar to Example 1, except that polyoxyethylene alkyl ether (Emarumine 40; HLB=8.0; made by Sanyo Kasei K.K.) was used instead of polyoxyethylene nonyl phenyl ether as a surfactant added into the surface layer.

### EXAMPLE 13

A base layer, an intermediate layer and a surface layer were formed in a manner similar to Example 1, except that polyoxyethylene sorbitan fatty acid ester (Ionet T-20C; HLB=16.7; made by Sanyo Kasei K.K.) was used instead of polyoxyethylene nonyl phenyl ether as a surfactant added into the surface layer.

### COMPARATIVE EXAMPLE 1

Base layer: A PET sheet with a thickness of 150 μm was used as a base layer.

Intermediate layer: A resin solution was prepared by dissolving 14 g of a polycarbonate resin in 186 g of tetrahydrofuran. Four grams of isocyanete (Desmodur RFE: made by Sumitomo Bayer K.K.) were added to the resin solution and stirred. The resulting solution was applied onto the base layer by a bar coater, and heated at 80° C. for 3 minutes, to form an intermediate layer of 2 μm thickness.

Surface layer: A resin solution was prepared by dissolving 12 g of polyvinyl alcohol CM-318 (made by Kuraray K.K.) as a water-soluble resin in 188 g of water. Melamine-formaldehyde resin (0.5 g) as a crosslinking agent, 0.6 g of ammonium chloride and 2 g of silica fine particles (SYLYSIA 450: made by Fuji Sylysia K.K.) (inorganic fine particles) were added to the resin solution and stirred for five minutes. The resulting solution was applied onto the intermediate layer by a bar coater, and heated at 120° C. for 2 hours to form a surface layer of 8 μm thickness.

Evaluation

Images were formed on the image-recording media obtained in Examples 1 to 13 and Comparative Example 1 by use of a laser beam printer (LP-1700; made by Epson K.K.) available in the market.

Images formed on the image-recording media were removed by use of the apparatus of FIG. 4, to evaluate a time period necessary for removing images and durability. The results are summarized in Table 1.

The evaluation of the time period necessary for removing images were carried out to measure an immersion time of period from water-supply to the point when the images can be removed acceptably. When 95% or more of images could be removed in 100 seconds, the evaluation was ranked as “⊚”. When 95% or more of images could be removed in 200 seconds, the evaluation was ranked as “∘”. When 95% or more of images could be removed in 400 seconds, the evaluation was ranked as “Δ”. When it took 400 or more seconds to remove 95% or more of images, the evaluation was ranked as “×”.

After a process from copy to toner removal was repeated 20 times, the same evaluation as above was made to evaluate durability.

The operating conditions of the apparatus of FIG. 4 were as follows:

Brushing roller; the brush roller having a metal core diameter of 12 mm and having nylon brushing hair with length of 10 mm and thickness of 30 μm

Tank water temperature: 30° C.

Paper-feeding speed: 1 cm/second

Brush-rotational speed/Paper-Feeding speed=30

Heat roller temperature: 110° C. Table 1

| | Initial | Repetition |
|---|---|---|
| Example 1 | ⊚ | ⊚ |
| Example 2 | ⊚ | ⊚ |
| Example 3 | ⊚ | ◯ |
| Example 4 | ⊚ | ◯ |
| Example 5 | ⊚ | ⊚ |
| Example 6 | ◯ | ◯ |
| Example 7 | ⊚ | ⊚ |
| Example 8 | ⊚ | ⊚ |
| Example 9 | ⊚ | ⊚ |
| Example 10 | ⊚ | ◯ |
| Example 11 | ⊚ | ⊚ |
| Example 12 | ◯ | Δ |
| Example 13 | ◯ | Δ |
| Comparative | ◯ | X |
| Example 1 | | |

What is claimed is:

1. An image-recording medium comprising:
a base layer; and
a water-swelling surface layer containing a surfactant.

2. The image-recording medium of claim 1, in which the water-swelling surface layer comprises a water-soluble resin crosslinked with a crosslinking agent.

3. The image-recording medium of claim 2, in which the water-soluble resin is selected from the group consisting of resins having a hydroxyl group, an amino group, an amide group, a thiol group, a carboxyl group, a sulfonic group and a mixture thereof, and the crosslinking agent is selected from the group consisting of epoxy compounds, isocyanate compounds, glyoxals, methylol compounds, melamine compounds (resins), dicarboxylic acids, aziridines, dihydrazides and a mixture thereof.

4. The image-recording medium of claim 1, in which the surfactant is an anionic surfactant or a nonionic surfactant.

5. The image-recording medium of claim 1, in which the surfactant is a nonionic surfactant having a hydrophilic-lipophilic balance (HLB) of 9 to 15.

6. The image-recording medium of claim 1, in which the surfactant comprises at least one compound selected from the group consisting of:
R₁—R₂—O—(EO)n₁H (i)
in which R₁ is an alkyl group having carbon atoms of 7 to 14; R₂ is a phenylene group or a naphthylene group; and n₁ is an integer of 3 to 40; and
R₃—O—(EO)n₂H (ii)
in which R₃ is an alkyl group having carbon atoms of 7 to 14; and n₂ is an integer of 3 to 40.

7. The image-recording medium of claim 1, in which the surfactant comprises at least one compound selected from the group consisting of:
R₄—R₅—SO₃—A (iii)
in which R₄ is an alkyl group having carbon atoms of 7 to 14; R₅ is a phenylene group or a naphthylene group; and A is an alkali metal; 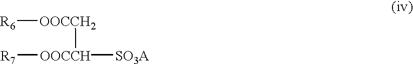
in which R₆ and R₇ are respectively an alkyl group having carbon atoms of 7 to 14; and A is an alkali metal; 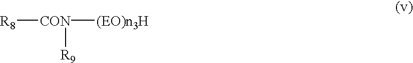
in which R₈ is an alkyl group having carbon atoms of 7 to 20; R₉ is a hydrogen atom or —CH₂CH₂OH; and n₃ is an integer of 1 to 10;
R₁₀O(EO)n₄SO₃A (vi)
in which R₁₀ is an alkyl group having carbon atoms of 7 to 15; n₄ is an integer of 1 to 10; and A is an alkali metal; and
R₁₁O(EO)n₅SO₃NH((EO)n₆H)₃ (vii)
in which R₁₁ is an alkyl group having carbon atoms of 7 to 14; n₅ is an integer of 0 to 7; and n₆ is an integer of 1 to 3.

8. The image-recording medium of claim 1, in which the surface layer has inorganic fine particles or resin fine particles dispersed therein.

9. The image-recording medium of claim 8, in which the inorganic fine particles are selected from the group consisting of titanium oxide, alumina, zinc oxide, calcium carbonate and a mixture thereof, and the resin fine particles are selected from the group consisting of acrylic resins, styrene resins and a mixture thereof.

10. The image-recording medium of claim 1, in which the surface layer contains an antistatic agent.

11. An image-recording medium comprising:
a base layer;
an intermediate layer; and
a water-swelling surface layer containing a surfactant.

12. The image-recording medium of claim 11, in which the intermediate layer comprises a resin selected from the group consisting of polymethyl methacrylate resins, polyester resins, polycarbonate resins, vinyl chloride resins, urethane resins and a mixture thereof.

13. The image-recording medium of claim 11, in which the intermediate layer comprises methylol compounds, isocyanate compounds, aldehyde compounds, epoxy compounds, aziridine compounds and a mixture thereof.

14. The image-recording medium of claim 11, in which the water-swelling surface layer comprises a water-soluble resin crosslinked with a crosslinking agent.

15. The image-recording medium of claim 14, in which the water-soluble resin is selected from the group consisting of resins having a hydroxyl group, an amino group, an amide group, a thiol group, a carboxyl group, a sulfonic group and a mixture thereof, and the crosslinking agent is selected from the group consisting of epoxy compounds, isocyanate compounds, glyoxals, methylol compounds, melamine compounds (resins), dicarboxylic acids, aziridines, dihydrazides and a mixture thereof.

16. The image-recording medium of claim 11, in which the surfactant is an anionic surfactant or a nonionic surfactant.

17. The image-recording medium of claim 11, in which the surfactant is a nonionic surfactant having a hydrophilic-lipophilic balance (HLB) of 9 to 15.

18. The image-recording medium of claim 11, in which the surfactant comprises at least one compound selected from the group consisting of:
R₁—R₂—O—(EO)n₁H (i)
in which R₁ is an alkyl group having carbon atoms of 7 to 14; R₂ is a phenylene group or a naphthylene group; and n₁ is an integer of 3 to 40; and
R₃—O—(EO)n₂H (ii)
in which R₃ is an alkyl group having carbon atoms of 7 to 14; and n₂ is an integer of 3 to 40.

19. The image-recording medium of claim 11, in which the surfactant comprises at least one compound selected from the group consisting of:
R₄—R₅—SO₃—A (iii)
in which R₄ is an alkyl group having carbon atoms of 7 to 14; R₅ is a phenylene group or a naphthylene group; and A is an alkali metal; 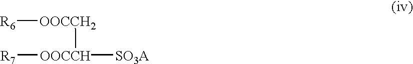
in which R₆ and R₇ are respectively an alkyl group having carbon atoms of 7 to 14; and A is an alkali metal; 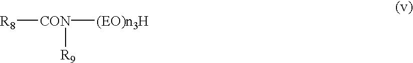
in which R₈ is an alkyl group having carbon atoms of 7 to 20; R₉ is a hydrogen atom or —CH₂CH₂OH; and n₃ is an integer of 1 to 10;
R₁₀O(EO)n₄SO₃A (vi)
in which R₁₀ is an alkyl group having carbon atoms of 7 to 15; n₄ is an integer of 1 to 10; and A is an alkali metal; and
R₁₁O(EO)n₅SO₃NH((EO)n₆H)₃ (vii)
in which R₁₁ is an alkyl group having carbon atoms of 7 to 14; n₅ is an integer of 0 to 7; and n₆ is an integer of 1 to 3.

20. The image-recording medium of claim 11, in which the surface layer has inorganic fine particles or resin fine particles dispersed therein.
